(19) United States
(12) Patent Application Publication
(10) Pub. No.: US 2018/0326401 A1
(43) Pub. Date: Nov. 15, 2018

(54) TITANIUM DIOXIDE COMPOSITIONS AND THEIR USE AS DEPOLLUTING AGENTS

(71) Applicant: Cristal USA Inc., Glen Burnie, MD (US)

(72) Inventors: David M. Chapman, Ellicott City, MD (US); Anthony Wagstaff, Gunness, Scunthorpe (GB)

(21) Appl. No.: 15/776,894

(22) PCT Filed: Nov. 18, 2016
(86) PCT No.: PCT/IB2016/056977

§ 371 Date: May 17, 2018

Related U.S. Application Data
(60) Provisional application No. 62/257,868, filed on Nov. 20, 2015.

(51) Int. Cl. B01J 21/06; C01G 23/047; B01J 23/06; C01G 9/02; B01D 53/14

(52) U.S. Cl. CPC B01J 21/063; C01G 23/047; B01J 23/06; C01P 2002/01; B01D 53/1468; C01P 2002/52; C01G 9/02

(57) ABSTRACT

The disclosure provides a metal oxide-doped titanium dioxide (TiO₂) composition, with a solid phase including TiO₂ and one or more metal oxides and a liquid phase. Methods of preparing such doped compositions are also provided. The doped compositions disclosed herein can exhibit adsorption and photocatalytic properties, particularly in the context of treating gas streams containing H₂S gas (e.g., to reduce atmospheric pollution).

### FIELD OF THE INVENTION

The present invention relates to photoactive neutral titanium dioxide (TiO₂)-based materials. The invention further relates to making such materials and using such materials, e.g., for removal of pollutants from gas streams.

### BACKGROUND OF THE INVENTION

Hydrogen sulfide (H₂S) is a gas that is naturally present in small amounts (e.g., in volcanic gases, natural gas, and certain rock salts). Hydrogen sulfide is formed as a byproduct of many industrial processes (e.g., in petroleum refineries, wherein hydrodesulfurization of petroleum releases sulfur by the action of hydrogen and in coal-fired power plants, wherein sulfur is converted to hydrogen sulfide). Other emitters of H₂S include mining operations, paper and pulp processing facilities, rayon manufacturers, and tanneries. Hydrogen sulfide can also be produced by the bacterial breakdown of organic matter (e.g., in agricultural silos and sewage) in the absence of oxygen, especially at high temperatures.

The release of hydrogen sulfide from these and other sources presents environmental and health risks. Hydrogen sulfide has a characteristic, offensive odor and extended exposure to H₂S (e.g., through breathing contaminated air or drinking contaminated water) can lead to a range of health problems, ranging from eye irritation, nausea, dizziness, and the like to unconsciousness and death. Hydrogen sulfide can also lead to corrosion of concrete and metals, e.g., in municipality wastewater collection and treatment systems. The Environmental Protection Agency has reported that sewers designed to last 50 to 100 years have failed due to hydrogen sulfide corrosion in as little as 10 to 20 years and that associated electrical and mechanical equipment with an expected source life of 20 years has required replacement in as little as 5 years. In addition to hydrogen sulfide, various other gases (e.g., pollutants), including, but not limited to, other sulfur-containing gases, are known to present such risks. It would be beneficial to provide compositions and methods capable of removing hydrogen sulfide and other gases from various environments to address these concerns.

Titanium oxide sols are generally known and have been shown to promote the breakdown of a range of atmospheric pollutants. However, such sols exhibit little to no effective removal of H₂S. Accordingly, it would be beneficial to provide compositions in the form of a sol that can function in this manner. As sols are generally applicable for various purposes other than gas abatement, such compositions can be more generally useful in a wide range of applications.

### SUMMARY OF THE INVENTION

The present disclosure provides doped compositions (e.g., sols), methods of preparing such doped compositions, and methods of using such doped compositions. Particularly, the disclosure provides sols that comprise TiO₂, which can exhibit photocatalytic capabilities. According to the disclosure herein, the TiO₂-containing sols are doped with one or more additional components, e.g., metal oxides.

In one particular aspect, the disclosure provides a composition (e.g., sol) comprising: a solid phase comprising a first and second metal oxide, wherein the first metal oxide is titanium dioxide (TiO₂); and a liquid phase. The second metal oxide is an oxide of a metal other than titanium (i.e., comprising a metal different than the metal of the first metal oxide). In certain embodiments, the first and second metal oxides are uniformly dispersed throughout the doped composition. At least a portion of the first and second metal oxides can, in some embodiments, be closely associated with one another. For example, in some embodiments, at least a portion (e.g., about 50% or more or about 75% or more by weight) of the second metal oxide is adhered to at least a portion of the first metal oxide. In some embodiments, at least a portion (e.g., about 50% or more or about 75% or more by weight) of the second metal oxide is in the form of a coating on at least a portion of the first metal oxide. In certain embodiments, the doped compositions disclosed herein are transparent. The doped compositions can, in some embodiments, be provided in neutral form and, for example, can have a pH of about 6 to about 9. The doped compositions disclosed herein can, in some embodiments, further comprise a water-soluble peptizing agent, e.g., an alkaline agent such as an amine, and as a particular example, the compositions can comprise diethylamine as a peptizing agent.

The composition of the second metal oxide can vary and, in some embodiments, may be selected from the group consisting of aluminum oxides, chromium oxides, zinc oxides, iron oxides, copper oxides, nickel oxides, cobalt oxides, molybdenum oxides, niobium oxides, manganese oxides, calcium oxides, barium oxides, strontium oxides, tungsten oxides, vanadium oxides, and mixed metal oxides thereof. In particular embodiments, the second metal oxide is selected from the group consisting of zinc oxides, copper oxides, and mixed metal oxides thereof. In certain embodiments, the compositions disclosed herein can further comprise chloride ions. The doped compositions provided can, in some embodiments, comprise about 1% to about 15% by weight of the second metal oxide.

The doped compositions can comprise, for example, between about 5% and about 20% by weight of the TiO₂ (based on the entirety of the composition). The TiO₂ present in the doped compositions disclosed herein can be in various forms. In some embodiments, a majority, such as about 90% by weight or more of the TiO₂ present in the doped compositions is in the anatase phase. The TiO₂ can be, for example, in the form of crystallites having a primary particle size of about 10 nm to about 60 nm. The liquid phase of the doped compositions can, in some embodiments, comprise water. In certain doped compositions, the weight ratio of first metal oxide to second metal oxide in the composition is greater than about 1:1, including, but not limited to, about 1.1:1 or greater, such as about 1.1:1 to about 20:1 or about 1.5:1 to about 20:1.

In another aspect, the present disclosure provides a method of preparing a metal oxide-doped TiO₂ composition (e.g., sol) comprising: providing a composition, wherein the composition comprises a solid phase comprising titanium dioxide (TiO₂) and a liquid phase; and combining the composition with one or more metal compounds or metal salts under conditions sufficient to result in reaction of the metal of the one or more metal compounds or metal salts to form a metal oxide, wherein the metal oxide is a metal oxide other than TiO₂, to give a metal oxide-doped TiO₂ composition. The compositions of this method (in undoped and/or undoped form) can, in some embodiments, comprise ultrafine TiO₂ crystallites, e.g., in the form of crystallites having a primary particle size of about 10 nm to about 60 nm. In some embodiments, at least a portion of the metal oxide forms such that it adheres to at least a portion of the TiO₂. In some specific embodiments, the metal oxide is in the form of a coating (partial or full coating) on at least a portion of the TiO₂ (e.g., the TiO₂ crystallites).

The metal compounds or metal salts can, in some embodiments, be selected from metal salts and metal oxides. In various embodiments, the metal compounds or metal salts employed in the methods disclosed herein can be selected from the group consisting of aluminum salts, chromium salts, zinc salts, iron salts, copper, nickel salts, cobalt salts, molybdenum salts, niobium salts, manganese salts, calcium salts, barium salts, strontium salts, tungsten salts, vanadium salts, and combinations thereof. Certain representative metal salts include, but are not limited to, metal salts are selected from the group consisting of zinc salts, copper salts, and combinations thereof. In some embodiments, the metal compounds or metal salts employed in the methods disclosed herein can be selected from the group consisting of halides, acetates, perchlorates, hydroxides, sulfates, sulfonates, nitrates, nitrites, oxides, trifluoroacetates, carbonates, bicarbonates, phosphates, tetrafluoroborates, citrates, periodates, pyruvates, triflates, acrylates, methacrylates, acetonates, azides, cyanides, methoxides, ethoxides, t-butoxides, isopropoxides, benzoates, and derivatives and combinations thereof. Certain representative metal salts include, but are not limited to, metal halides and/or metal acetates.

In some embodiments, the metal compounds or metal salts are in solution form, e.g., including, but not limited to, in solution with water. In some embodiments, the metal compounds or metal salts are in the form of a gel comprising a metal oxide. The pH of the TiO₂ composition can, for example, be such that the sol is basic prior to combining the TiO₂ composition with the one or more metal compounds or metal salts; accordingly, in some embodiments, the method can further comprise adjusting the pH of the TiO₂ composition (e.g., by addition of acid or base) prior to combining the TiO₂ composition with the one or more metal compounds or metal salts. Still further, the resulting doped composition can, in some embodiments, be treated, e.g., by adjusting the pH thereof, such as adjusting the pH to give a composition having a pH of about 6 to about 9.

In a further aspect, the disclosure provides a method of treating a gas comprising H₂S, comprising contacting the gas comprising H₂S with a metal oxide-doped TiO₂ sol such that at least a portion of the H₂S is adsorbed and such that at least a portion of the adsorbed H₂S is oxidized. The disclosure further provides a method of reducing atmospheric pollution, comprising contacting a gas comprising H₂S with a metal oxide-doped TiO₂ composition such that at least a portion of the H₂S is adsorbed and such that at least a portion of the adsorbed H₂S is oxidized, wherein the metal oxide-doped TiO₂ composition comprises: a solid phase comprising a first and second metal oxide, wherein the first metal oxide is titanium dioxide (TiO₂); and a liquid phase. In certain embodiments, the metal oxide-doped TiO₂ sol used in such methods can be in the form of a dried film. In one particular embodiment, the metal oxide-doped TiO₂ sol with which the H₂S-containing gas is contacted comprises zinc oxide and further comprises chloride ions.

The invention includes, without limitation, the following embodiments.

### EMBODIMENT 1

A composition comprising: a solid phase comprising a first and second metal oxide, wherein the first metal oxide is titanium dioxide (TiO₂); and a liquid phase.

### EMBODIMENT 2

The composition of any preceding or subsequent embodiment, wherein the first and second metal oxide are uniformly dispersed throughout the composition.

### EMBODIMENT 3

The composition of any preceding or subsequent embodiment, wherein at least a portion of the second metal oxide is adhered to at least a portion of the first metal oxide.

### EMBODIMENT 4

The composition of any preceding or subsequent embodiment, wherein at least about 75 weight percent of the second metal oxide is adhered to at least a portion of the first metal oxide.

### EMBODIMENT 5

The composition of any preceding or subsequent embodiment, wherein at least a portion of the second metal oxide is in the form of a coating on at least a portion of the first metal oxide.

### EMBODIMENT 6

The composition of any preceding or subsequent embodiment, wherein the second metal oxide is selected from the group consisting of aluminum oxides, chromium oxides, zinc oxides, iron oxides, copper oxides, nickel oxides, cobalt oxides, molybdenum oxides, niobium oxides, manganese oxides, calcium oxides, barium oxides, strontium oxides, tungsten oxides, vanadium oxides, and mixed metal oxides thereof.

### EMBODIMENT 7

The composition of any preceding or subsequent embodiment, wherein the second metal oxide is selected from the group consisting of zinc oxides, copper oxides, and mixed metal oxides thereof.

### EMBODIMENT 8

The composition of any preceding or subsequent embodiment, further comprising chloride ions.

### EMBODIMENT 9

The composition of any preceding or subsequent embodiment, wherein the composition comprises about 1% to about 15% by weight of the second metal oxide.

### EMBODIMENT 10

The composition of any preceding or subsequent embodiment, wherein about 90% or more by weight of the first metal oxide is in the anatase phase.

### EMBODIMENT 11

The composition of any preceding or subsequent embodiment, wherein the composition comprises about 5% to about 20% by weight of the first metal oxide.

### EMBODIMENT 12

The composition of any preceding or subsequent embodiment, wherein the TiO₂ is in the form of crystallites having a primary particle size of about 10 nm to about 60 nm.

### EMBODIMENT 13

The composition of any preceding or subsequent embodiment, wherein the weight ratio of first metal oxide to second metal oxide in the composition is greater than about 1:1.

### EMBODIMENT 14

The composition of any preceding or subsequent embodiment, wherein the weight ratio of first metal oxide to second metal oxide in the composition is about 1.1:1 to about 20:1.

### EMBODIMENT 15

The composition of any preceding or subsequent embodiment, wherein the composition is transparent.

### EMBODIMENT 16

The composition of any preceding or subsequent embodiment, wherein the composition has a pH of about 6 to about 9.

### EMBODIMENT 17

The composition of any preceding or subsequent embodiment, wherein the liquid phase comprises water.

### EMBODIMENT 18

The composition of any preceding or subsequent embodiment, wherein the liquid phase further comprises one or more water-soluble peptizing agents.

### EMBODIMENT 19

The composition of any preceding or subsequent embodiment, wherein the composition is a sol.

### EMBODIMENT 20

The composition of any preceding or subsequent embodiment, the second metal oxide is selected from the group consisting of zinc oxides, copper oxides, and mixed metal oxides thereof; the composition comprises about 5% to about 15% by weight of the second metal oxide; the composition comprises about 5% to about 20% by weight of the first metal oxide; and the weight ratio of first metal oxide to second metal oxide in the composition is greater than about 1:1.

### EMBODIMENT 21

A method of preparing a metal oxide-doped TiO₂ composition comprising: providing a composition, wherein the composition comprises a solid phase comprising titanium dioxide (TiO₂) and a liquid phase; and combining the composition with one or more metal compounds or metal salts under conditions sufficient to result in reaction of the metal of the one or more metal compounds or metal salts to form a metal oxide, wherein the metal oxide is a metal oxide other than TiO₂, to give a metal oxide-doped TiO₂ composition.

### EMBODIMENT 22

The method of any preceding or subsequent embodiment, wherein the TiO₂ is in the form of crystallites having a primary particle size of about 10 nm to about 60 nm.

### EMBODIMENT 23

The method of any preceding or subsequent embodiment, wherein the liquid phase comprises water.

### EMBODIMENT 24

The method of any preceding or subsequent embodiment, wherein the liquid phase further comprises one or more water-soluble peptizing agents.

### EMBODIMENT 25

The method of any preceding or subsequent embodiment, wherein the at least a portion of the metal oxide forms such that it adheres to at least a portion of the TiO₂.

### EMBODIMENT 26

The method of any preceding or subsequent embodiment, wherein the one or more metal compounds or metal salts are selected from the group consisting of aluminum salts, chromium salts, zinc salts, iron salts, copper, nickel salts, cobalt salts, molybdenum salts, niobium salts, manganese salts, calcium salts, barium salts, strontium salts, tungsten salts, vanadium salts, and combinations thereof.

### EMBODIMENT 27

The method of any preceding or subsequent embodiment, wherein the one or more metal compounds or metal salts are selected from the group consisting of zinc salts, copper salts, and combinations thereof.

### EMBODIMENT 28

The method of any preceding or subsequent embodiment, wherein the one or more metal compounds or metal salts are selected from the group consisting of halides, acetates, perchlorates, hydroxides, sulfates, sulfonates, nitrates, nitrites, oxides, trifluoroacetates, carbonates, bicarbonates, phosphates, tetrafluoroborates, citrates, periodates, pyruvates, triflates, acrylates, methacrylates, acetonates, azides, cyanides, methoxides, ethoxides, t-butoxides, isopropoxides, benzoates, and derivatives and combinations thereof.

### EMBODIMENT 29

The method of any preceding or subsequent embodiment, wherein the one or more metal compounds or metal salts are selected from the group consisting of metal halides and metal acetates

### EMBODIMENT 30

The method of any preceding or subsequent embodiment, wherein the metal compounds or metal salts are in solution form.

### EMBODIMENT 31

The method of any preceding or subsequent embodiment, wherein the one or more metal compounds or metal salts are in the form of a gel comprising a metal oxide.

### EMBODIMENT 32

The method of any preceding or subsequent embodiment, wherein the composition is basic prior to said combining step.

### EMBODIMENT 33

The method of any preceding or subsequent embodiment, further comprising adjusting the pH after the combining step to give a metal oxide-doped TiO₂ composition having a pH of about 6 to about 9.

### EMBODIMENT 34

A method of reducing atmospheric pollution by treating a gas comprising H₂S, comprising contacting the gas comprising H₂S with a metal oxide-doped TiO₂ composition such that at least a portion of the H₂S is adsorbed and such that at least a portion of the adsorbed H₂S is oxidized, wherein the metal oxide-doped TiO₂ composition comprises: a solid phase comprising a first and second metal oxide, wherein the first metal oxide is titanium dioxide (TiO₂); and a liquid phase.

### EMBODIMENT 35

The method of any preceding or subsequent embodiment, wherein the metal oxide-doped TiO₂ composition is in the form of a dried film.

### EMBODIMENT 36

The method of any preceding or subsequent embodiment, wherein the metal oxide-doped TiO₂ composition comprises zinc oxide and further comprises chloride ions.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a Transmission Electron Micrograph (TEM) image of an undoped TiO₂ sol;

FIG. 2 is a TEM image of a TiO₂ sol doped with 5% zinc oxide by weight of the sol;

FIG. 3 is a TEM image of a TiO₂ sol doped with 5% zinc oxide with chloride by weight of the sol;

FIG. 4 is a TEM image of a TiO₂ sol doped with 10% zinc oxide with chloride by weight of the sol;

FIG. 5 is a TEM image of a TiO₂ sol doped with 1% copper oxide by weight of the sol; and

FIG. 6 is a TEM image of a TiO₂ sol doped with 5% copper oxide by weight of the sol; and

FIG. 7 is a representation of the process steps associated with one embodiment of the presently disclosed method;

FIG. 8 is a graph presenting NOx reduction of various sol-coated materials under a UV light source;

FIG. 9 is a graph presenting NOx reduction of various sol-coated materials under a fluorescent light source;

FIG. 10 is a graph presenting NOx reduction of various sol-coated concrete panels under a UV light source; and

FIG. 11 is a graph demonstrating SO₄²⁻ accumulation by various sol-coated panels over time.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The disclosure provides compositions comprising titanium dioxide (TiO₂). Certain TiO₂ materials are known to be photocatalytic, i.e., function as catalysts in the presence of light (e.g., ultraviolet light). In this catalytic capacity, such TiO₂ materials do not readily degrade, and are generally maintained in their original form throughout use, allowing for continuous activity. In particular, ultrafine TiO₂, e.g., the CristalACTiV™ product line (Cristal, USA/Saudi Arabia), can function in this manner to promote the breakdown of various atmospheric pollutants. For example, ultrafine TiO₂ finds use in abatement of NOₓ (nitrogen oxides, including NO and NO₂), SOₓ (sulfur oxides, including SO and SO₂), and VOC (volatile organic chemical), emissions.

Advantageously, for some applications, photocatalytic TiO₂ materials can be provided in the form of TiO₂ sols. A sol is generally understood to be a colloidal suspension of particles, comprising a continuous liquid phase (e.g., comprising water) and a dispersed solid phase (e.g., comprising TiO₂). TiO₂ sols have been studied with respect to abatement of H₂S emissions. However, TiO₂ sols were found to exhibit no activity with respect to adsorbing or otherwise interacting with H₂S (as the inventors have analyzed TiO₂ sols after exposure to hydrogen sulfide gas, and such sols were found to contain no sulfur compounds, even after extended exposure).

According to the present disclosure, sols comprising TiO₂ and one or more other inorganic components (e.g., metal oxides), referred to herein as “dopants” or “doping agents” are provided. Such sols are discussed herein as “doped sols,” meaning that they comprise one or more additional materials (i.e., dopants or doping agents) in the solid phase, in addition to the TiO₂. It is understood that, although these materials are referred to herein as dopants or doping agents, this terminology is not intended to be limiting of the method of manufacturing the doped sols. For example, the dopant(s) present within a doped sol may not be in the form in which they were added (i.e., the material added may react within the sol to form another species therein), and it is the final species present in the sol that is referred to herein as the dopant or doping agent. Dopants that find particular use in certain embodiments of the disclosed materials may be those components that are capable of capturing (e.g., adsorbing) hydrogen sulfide gas. Advantageously, by combining the adsorption capabilities of certain inorganic materials (e.g., dopants as disclosed herein) with the photocatalytic capabilities of TiO₂ in such embodiments, a unique material can be afforded, which is capable of both capturing and oxidizing certain undesirable gases (e.g., including, but not limited to, H₂S).

The titanium dioxide employed in the compositions disclosed herein is generally ultrafine (also referred to as nanoparticulate) titanium dioxide. Such ultrafine titanium dioxide typically has a primary particle size of about 1 nm to about 100 nm, e.g., having a primary particle size of about 10 nm to about 60 nm. The particles of ultrafine TiO₂ generally agglomerate within the sol, with larger primary particle sizes resulting (e.g., greater than about 100 nm). Exemplary ultrafine titanium dioxide includes titanium dioxide sold under the CristalACTiV™ product line (Cristal, USA/Saudi Arabia).

The titanium dioxide can be in varying crystalline phases (anatase and/or rutile phases). However, it is noted that a significant portion of the TiO₂ is advantageously in the anatase crystalline form, as this form exhibits higher photoactivity than the rutile form. For example, in certain embodiments, about 50% or more, about 60% or more, about 70% or more, about 80% or more, about 90% or more, or about 95% or more of the TiO₂ is in anatase form (including embodiments wherein about 100% of the TiO₂ is in anatase form). Consequently, in some embodiments, the TiO₂ in certain embodiments comprises about 20% or less, about 10% or less, about 5% or less, about 2.5% or less, or about 1% or less by weight TiO₂ in rutile form.

Although in many embodiments, a single type of titanium dioxide is used, it is noted that, in some embodiments, more than one type of titanium dioxide can be used. Accordingly, the disclosure is intended to include compositions wherein bimodal titanium dioxide materials are provided, resulting from the combination of two or more different titanium dioxide powders or sols, wherein at least one, and preferably both, have properties as defined above. Particle characterization can be carried out using known techniques, such as transmission electron microscopy (TEM), X-ray diffraction spectroscopy (XRD), or light scattering techniques (such as dynamic light scattering, by Malvern Instruments Ltd., U.K.). The crystallinity of the TiO₂ and the relative percentages of anatase and rutile phases can be measured, for example, by X-ray diffraction.

The liquid(s) present in the doped sols (making up the liquid phase of the sol) can further vary. Typically, the liquid phase of the doped sols disclosed herein comprises one or more liquids in which the TiO₂ and dopants are substantially insoluble (i.e., such that the TiO₂ and dopants remain dispersed in the liquid phase). One suitable liquid phase useful in the sols disclosed herein is an aqueous liquid (e.g., demineralized water). In certain embodiments, an organic solvent, such as a water-miscible organic solvent, can be used alone or in combination with water, such as an alcohol (e.g., ethanol or isopropanol). In certain embodiments, the doped sols can further comprise one or more additional components, e.g., one or more peptizing agents or derivatives thereof, as generally described herein above. Preferably, the one or more peptizing agents are soluble in the liquid phase, such that the liquid phase of the disclosed TiO₂ sols and the doped sols comprises the peptizing agents.

The dopant or dopants in the doped TiO₂ sols disclosed herein can vary. Certain dopants encompassed by the present disclosure are metal oxides (other than TiO₂). Metal oxides are generally understood to contain one or more metal atoms in combination with one or more oxygen atoms. The metal in the metal oxide included within certain sols as disclosed herein can be in varying oxidation states and the bond between the metal and the one or more oxygen atoms in the metal oxide can range from ionic to covalent in nature. However, the metal oxides are a component of the solid phase of the sol; accordingly, the metal oxides useful according to the present disclosure are insoluble or substantially insoluble in the liquid phase (e.g., insoluble in water). Exemplary metal oxides include, but are not limited to, oxides of transition metals, oxides of alkali metals, and oxides of alkaline earth metals. In some embodiments, metal oxides comprising transition metals may be used. Certain metal oxides that can serve as dopants include, but are not limited to, various oxides of aluminum, chromium, zinc, iron, copper, cobalt, molybdenum, niobium, manganese, barium, strontium, tungsten, and vanadium.

In some embodiments, the dopant (or dopants) generally comprise dopants capable of capturing (e.g., adsorbing) one or more pollutant gases, such as hydrogen sulfide gas. Some such dopants are metal oxides, and representative metal oxides that may be useful in such embodiments include, but are not limited to, aluminum oxides (e.g., Al₂O₃), chromium oxides (e.g., Cr₂O₃ and Cr₃O₄), zinc oxides (e.g., ZnO), iron oxides (e.g., Fe₂O₃ and Fe₃O₄), copper oxides (e.g., CuO), nickel oxides, cobalt oxides (e.g., Co₃O₄), molybdenum oxides, niobium oxides (e.g., Nb₂O₅), manganese oxides (MnO), calcium oxides (e.g., CaO), barium oxides, strontium oxides, tungsten oxides, and vanadium oxides (e.g., V₂O₃) and mixed metal oxides thereof, and these metal oxides are exemplary dopants that can be effective in the doped metal sols disclosed herein.

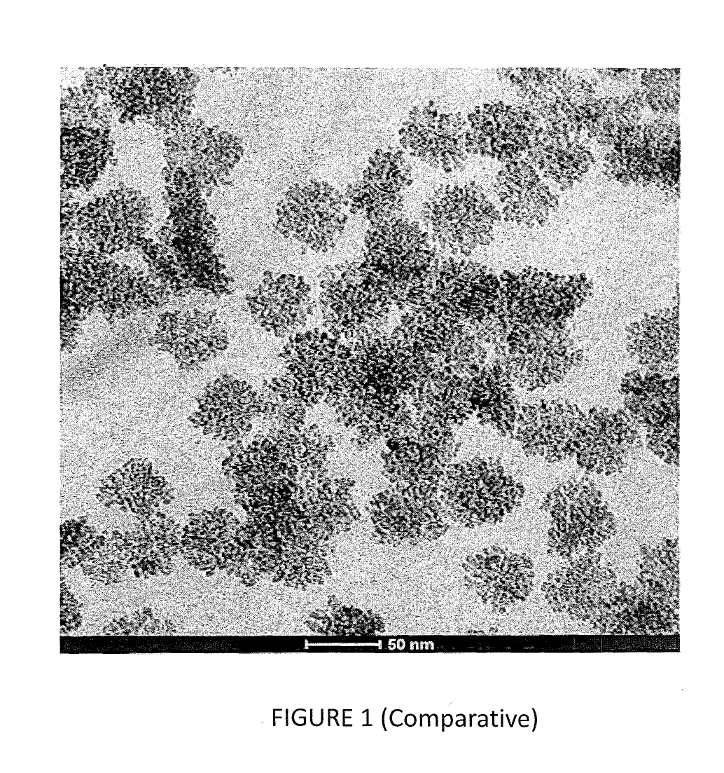

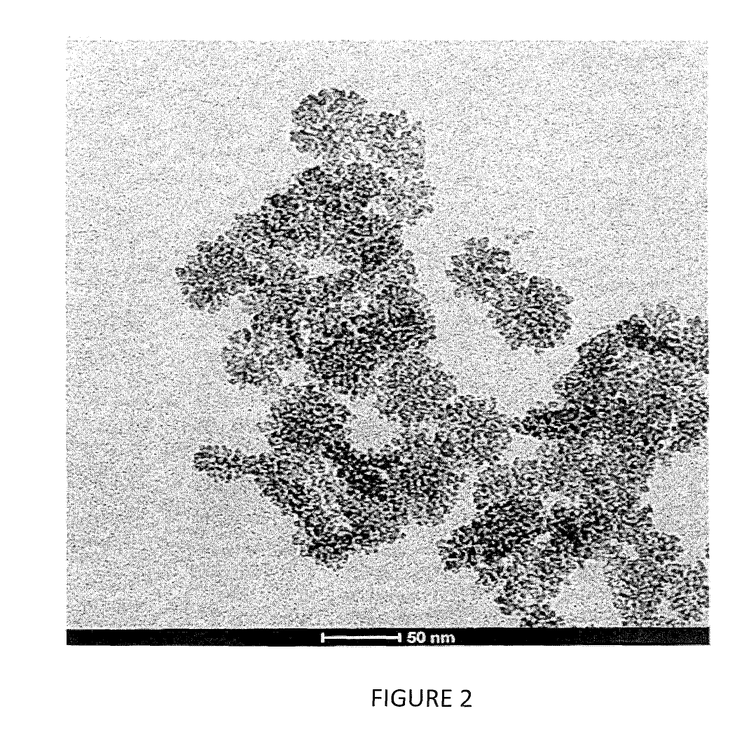

Advantageously, the dopant(s) are well dispersed within the TiO₂ sol, such that a substantially homogeneous solid phase is provided within the sol. Transmission electron micrographs, shown in FIGS. 1-6 indicate that the doped sols (FIGS. 2-6) appear comparable in structure to the undoped sol (FIG. 1), indicating that no separation between the dopant and the TiO₂ occurs. Based on the method of producing the doped sols disclosed herein, it is understood that the dopant is present in the sol (e.g., as no washing steps are conducted to remove any component that is added to the sol). When materials are added to a sol, they generally form separate agglomerates or associate with the solid phase of the sol (here, the TiO₂). The TEM images presented herein demonstrate that the latter occurs and, in particular, it is believed that the dopant forms on the surface of the TiO₂ particles.

Generally, the TEM images indicate that the dopants are associated with the TiO₂ particles, e.g., present on the surfaces of the TiO₂ particles, rather than separately agglomerated. Accordingly, the disclosed doped sols can, in some embodiments, be said to comprise a solid phase comprising TiO₂ particles, wherein at least a portion of the surface of such TiO₂ particles comprises one or more metal oxide dopants associated therewith (e.g., adhered thereto). In some embodiments, the TiO₂ and the dopant(s) can be described as being substantially uniformly dispersed (including uniformly dispersed) throughout the sol. In some embodiments, the doped TiO₂ sol can be described as substantially uniform.

In some embodiments, the doped TiO₂ sol can be described as comprising TiO₂ particles, wherein at least a portion (e.g., at least about 50%, at least about 60%, at least about 70%, at least about 80%, at least about 90%, or substantially all) of the TiO₂ particles are associated with dopant (e.g., are coated at least partially with dopant). Analysis of trace metals, where desirable, can be carried out by inductively coupled plasma (ICP) spectrophotometric analysis.

The sols provided herein accordingly comprise a solid phase comprising TiO₂ and one or more dopants, and a liquid phase comprising one or more liquids. The liquid phase further can, in some embodiments, comprise one or more peptizing agents. The chemical composition of the doped sols can vary, as noted above and, further, the weight ratio of the components included within the sols can vary. In certain embodiments, doped TiO₂ sols are provided wherein the TiO₂ content within the sol is about 0.5% to about 20% by weight, based on the entirety of the doped sol, such as about 1% to about 15% by weight, about 5% to about 20% by weight, or about 5% to about 15% by weight. The dopant is typically present in a lower weight percentage than the TiO₂. For example, in some embodiments, the dopant(s) are present in an amount of up to about 20% by weight or up to about 15% by weight, such as about 0.1% to about 20%, such as about 0.5 to about 20%, about 1 to about 20%, about 5 to about 20%, about 0.1 to about 15%, about 0.5 to about 15%, about 1 to about 15%, or about 1% to about 10% by weight, based on the entirety of the doped sol.

In certain embodiments, the sols disclosed herein can comprise more TiO₂ by weight than dopant in the solid phase. For some embodiments, particularly where a metal oxide dopant coats the surface of TiO₂ particles, preferably only a portion of the TiO₂ surface area is coated. For example, in the context of employing the doped sols herein for remediation of H₂S-containing gases, it can be important for both a metal oxide and the TiO₂ to be readily available for interaction with the H₂S. Accordingly, in some embodiments, at least a portion of the TiO₂ particles are not associated with the dopant(s) and/or at least a portion of the TiO₂ particles are not completely coated with the dopant(s). In some embodiments, the amount of dopant is maintained at a level that is below that of the TiO₂ to ensure that some portion of the TiO₂ is uncoated with the metal oxide (i.e., exposed within the sol and/or available for reaction with component that are adsorbed or otherwise contained within the sol). For example, in certain embodiments, the TiO₂:dopant weight ratio can be greater than 1:1, such as greater than about 2:1, 3:1, 4:1, 5:1, or 10:1 (e.g., a TiO₂:dopant weight ratio of about 1:1 to about 50:1, such as about 1:1 to about 25:1 or about 1.5:1 to about 20:1).

The pH of the doped sols can vary. Advantageously, the doped sols exhibit a substantially neutral pH (e.g., about 6 to about 9, such as having a pH of about 6-8, 6-9, or 7-8). However, in various embodiments, the doped sols can be provided in acidic or basic form. Other desirable characteristics that are exhibited in certain embodiments of the present disclosure include, but are not limited to, substantially odorless, transparency in the doped sols and/or dried films produced therefrom, and stability. The transparency of the doped sols and films produced therefrom in certain embodiments can be observed, e.g., visually or by UV-visible spectroscopy. Stability is defined by the transparency of the material, i.e., wherein the sol does not visibly change in transparency over a one, two, or three month observation period at room temperature.

In some embodiments, the doped sols can optionally contain additional components (e.g., in addition to TiO₂, liquid, peptizing agent, and dopant), provided that the incorporation of such additional components does not significantly negatively impact the adsorption characteristics and/or the photocatalytic characteristics of the doped sols. Such additional components that may, in certain embodiments, be incorporated within the doped sols described herein, include, but are not limited to, minor amounts of bactericidal agents, organic solvents (e.g., alcohols), film-forming aids, sequestering agents, pH adjusters, and the like.

The doped sols can be provided in various forms. In some embodiments, the doped sols can be provided in liquid form and, in some embodiments, the doped sols can be provided in the form of a film. Such films can be used to coat a wide range of surfaces, the compositions of which are not particularly limited. Representative surfaces onto which the metal doped sols are advantageously deposited can include, but are not limited to, surfaces comprising one or more of cement/concrete, metal, glass, polymer, wood, ceramic, paper, textile (woven or nonwoven), leather, and the like. In some embodiments, the sol can be provided in a cast form (e.g., to provide the material in a desired shape, such as to form a stand-alone structure).

In some embodiments, the doped sols are advantageously heat stable, e.g., able to withstand the temperatures at which H₂S is generated and/or released. Although in some embodiments, the doped sols can be used to capture and treat H₂S at ambient temperature, in some embodiments, the doped sols are employed at elevated temperatures (e.g., greater than ambient temperature, such as about 25° C. to about 500° C., e.g., about 50° C. to about 250° C.). Advantageously, the H₂S capture and treatment capabilities of the doped sols disclosed herein do not significantly diminish after extended exposure to such elevated temperatures (e.g., over a time period of less than about 1 week, less than about 1 month, less than about 1 year, or less than about 2 years).

The doped sols can, in some embodiments, be transparent or translucent. Standard testing for transparency is described in ASTM D1003-13, Standard Test Method for Haze and Luminous Transmittance of Transparent Plastics. Other methods also may be employed. For example, the coating material can be applied to a clear glass substrate (e.g., a cuvette of a glass panel) by a suitable method, such as spraying or using a draw bar, to the desired coating thickness and then allowed to air dry. The so-formed samples can be tested in a UV Vis spectrometer using the same substrate (uncoated) as a blank. Transparency can be recorded as the average percent transmission over the wavelengths of 400 to 700 nm. Doped sol-based coatings according to the present disclosure preferably exhibit an average transmission over the wavelengths of 400-700 nm of at least about 50%, at least about 60%, at least about 70%, at least about 80%, or at least about 90% (e.g., about 50% to about 99%, about 60% to about 98%, or about 65% to about 95%). Advantageously, in certain embodiments, films produced from certain sols disclosed herein can also be transparent or translucent.

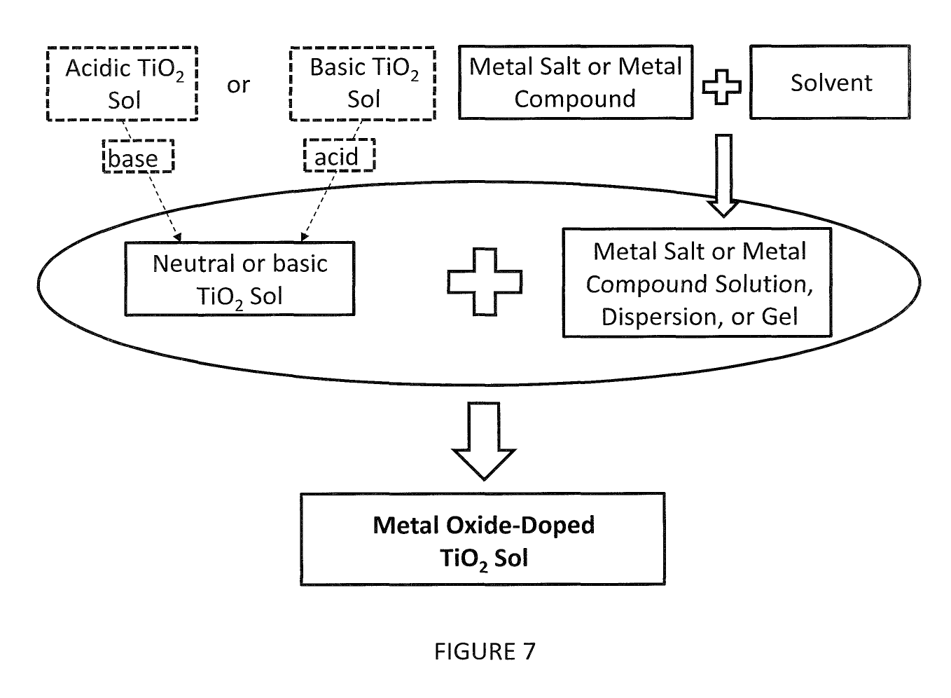

The doped sols provided herein can be prepared in various manners, and methods for their preparation are described herein below. A general scheme for the preparation of doped sols is shown in FIG. 7. As shown therein, in some embodiments, the method generally comprises combining a metal salt or metal compound (in various forms) with a titanium oxide sol to give a metal oxide-doped sol. The dashed lines indicate additional, optional steps that may be required where the sol is provided at a pH other than that desired for doped sol production.

Sols can generally be prepared by forming solid materials directly in a liquid (e.g., via agglomeration). Sols can also be prepared by dispersing a solid within a liquid. Photocatalytic TiO₂ and compositions thereof (including transparent or translucent TiO₂ sols), as well as methods of preparing such materials are disclosed in U.S. Pat. No. 5,049,309 to Sakamoto et al., U.S. Pat. No. 6,420,437 to Mori et al., U.S. Pat. No. 6,672,336 to Ohmori et al., U.S. Pat. No. 6,824,826 to Amadelli et al., U.S. Pat. No. 7,763,565 to Fu et al., U.S. Pat. No. 7,776,954 to Stratton et al., U.S. Pat. No. 7,932,208 to Fu et al., U.S. Pat. No. 7,935,329 to Im et al., U.S. Pub. No. 2007/0155622 to Goodwin et al., U.S. Pub. No. 2011/0159109 to Lee et al., U.S. Pub. No. 2011/0183838 to Fu et al., and U.S. Pub. No. 2013/0122074 to Kerrod et al., the disclosures of which are incorporated herein by reference.

In certain disclosed methods, a TiO₂ sol (e.g., as prepared according to one of the references noted hereinabove) is first provided. Sols can generally be provided in acidic, basic, or neutral form. In some embodiments, the preparation of a doped sol according to the present disclosure is based on a neutral sol (e.g., having a pH of about 6 to about 9, such as about 6 to about 8). Accordingly, in some embodiments, the provided TiO₂ sol is treated with acid or base (for basic or acidic sols, respectively) to provide the sol in substantially neutral state (having a pH of about 6 to about 9, advantageously about 6 to about 8). In such embodiments, a basic sol can be first neutralized using one or more acids. Although not intended to be limiting, exemplary acids include, but are not limited to, organic acids (e.g., citric acid, acetic acid, oxalic acid) or inorganic acids (e.g., phosphoric acid). In some embodiments, the addition of the optional acid to the TiO₂ sol can be controlled. For example, in certain embodiments, the TiO₂ sol is stirred with good agitation and the acid is added at a given rate (e.g., about 0.01 to about 0.1 g acid/min). The pH of the TiO₂ sol may be, in certain embodiments, monitored during the addition of the acid to ensure that the TiO₂ sol pH is within a particular range before stopping the addition of the acid. In other embodiments, the preparation of a doped sol is advantageously based on a basic sol. In such embodiments, it may be necessary to modify the pH of the sol, e.g., using acid or base to provide the sol in basic form.

Generally, one or more dopant precursors are then combined with the TiO₂ sol (e.g., the neutral or basic TiO₂ sol). The dopant precursor(s) can, in some embodiments, be added while the TiO₂ sol is being agitated (e.g., to ensure substantially homogeneous distribution of the dopant precursor within the sol). Although the addition rate can vary, in certain embodiments, it may be within the range of about 0.1 g/min to about 2 g/min (e.g., about 0.5 g/min to about 1.0 g/min). Although, in some embodiments, the doped sol preparation method is generally described herein in a step-wise process (i.e., adjusting the pH the sol and then adding the dopant precursor(s)), it is noted that the specific order of steps may vary. For example, in some embodiments, the acid or base is added substantially simultaneously with the dopant precursor. In some embodiments, a portion of acid or base is added, the dopant precursor is added, and then further acid or base is added. In some embodiments, the acid or base is continually added and the dopant precursor is added at a faster rate, at some point during the addition of the acid or base (such that, at some point, the dopant precursor(s) and acid or base are being added simultaneously).

The dopant precursor(s) can be added in varying forms, e.g., in solid form, solution form, or dispersion (including sol) form. Accordingly, the method of preparation of the doped sol can further comprise preparing one or more dopant precursor solutions or dispersions (including sols). Methods of preparing precursor solutions and dispersions of the materials useful as dopant precursors in the context of the present disclosure are generally known.

Where the dopant precursor is added in solution or dispersion form, the associated solvent and the concentration of the dopant precursor(s) can vary. In certain embodiments, the solvent is the same as the liquid phase of the TiO₂ sol to which the dopant precursor solution or dispersion is added (e.g., aqueous solution). However, it is not limited thereto and the solvent can generally be any solvent in which the dopant precursor can be solubilized or dispersed without negatively affecting the formation of the doped sol. In some embodiments, the dopant precursor is added in a solution or dispersion with industrial methylated spirits (“IMS”). Where more than one dopant precursor is added, the precursors can be added within the same solution or dispersion or two or more separate solutions or dispersions can be prepared and combined independently (simultaneously or sequentially) with the TiO₂ sol.

The dopant precursor can vary and is selected based on the particular metal (or metals) to be included in the final doped product. In certain embodiments, the dopant precursor is a metal compound or a metal salt. For example, to produce a copper oxide-doped TiO₂ sol, the dopant precursor is typically a copper salt or copper compound and to produce a zinc oxide-doped TiO₂ sol, the dopant precursor is typically a zinc salt or zinc compound.

The composition of the metal salt or compound can vary. Exemplary metals in the metal salts and compounds include, for example, the types of metals identified above which can be advantageously employed in the disclosed doped sols (e.g., including, but not limited to, aluminum, chromium, zinc, iron, copper, cobalt, molybdenum, niobium, manganese, barium, strontium, tungsten, and vanadium). The counter ion(s) for the metal in the metal salts and compounds can vary and may be organic or inorganic. They may be monoatomic or polyatomic. Although not intended to be limiting, exemplary counter ions for the metal atom(s) in the metal salts or compounds used to form the doped sols disclosed herein can, for example, be selected from the group consisting of halides (e.g., chloride, bromide, iodide), perchlorate, hydroxide, sulfate, sulfonate, nitrate, nitrite, acetate, trifluoroacetate, carbonate, bicarbonate, phosphate, tetrafluoroborate, citrate, periodate, pyruvate, triflate, acrylate, methacrylate, acetonate, azide, cyanide, methoxide, ethoxide, t-butoxide, isopropoxide, benzoate, and derivatives and combinations thereof. In some embodiments, metal atoms in the metal salts and compounds include those metals for which the metal oxide form is effective at adsorbing or otherwise reacting with H₂S (e.g., in gaseous form).

Metal salts and compounds used as dopant precursors according to the present disclosure can be anhydrous or can be in hydrated form (with varying numbers of water molecules associated therewith). Although in certain embodiments, a single metal dopant precursor is included, it is noted that in some embodiments, two or more metal dopant precursors are included (where the metal atoms in such metal dopant precursors can be the same or different). As such, in some embodiments, doped sols can be provided comprising two or more dopants (e.g., two or more metal oxides, in addition to TiO₂).

The concentration of dopant precursor added is generally that amount sufficient to provide the desired dopant content relative to TiO₂ in the final doped sol product. Typically, the number of moles of metal in the metal salt or metal compound added is equivalent to the moles of metal desired in the final doped sol product (as generally no purification/washing of the doped sol is done to remove any component therefrom). For example, where the desired dopant (metal oxide) content is about 1% metal oxide by weight, one of skill can calculate the number of moles of metal represented by that 1% metal oxide by weight (based on the total weight of the sol) and use that calculation to determine how much metal salt or compound to add. As a specific example, where 100 g of doped ZnO sol is to be prepared, a sol containing about 1% ZnO by weight contains about 12.3 mmol ZnO (and thus, 12.3 mmol Zn). Accordingly, if zinc acetate is used as the dopant precursor, it would be added in an amount calculated as 0.0123 mol zinc acetate ×219.5 g/mol=2.70 g zinc acetate. Of course, it is understood that this is a simplified calculation and the actual calculation would depend, e.g., on the dilution required to provide the end product doped sol (for which the calculated amount could be scaled accordingly).

Although not intending to be limited by theory, it is believed that, in certain embodiments, addition of a dopant precursor to a TiO₂ sol (comprising TiO₂, solvent, and peptizing agent) results in reaction between the dopant precursor and the peptizing agent. Reaction between the dopant precursor and the peptizing agent leads to the production of metal oxide within the sol. As noted herein above, the metal oxides that form can, in some embodiments, form directly on TiO₂ particles present within the sol or can become associated with TiO₂ particles (e.g., in the manners described above, e.g., by adhering to the surface of TiO₂ particles) after formation.

pH control during reaction may, in some embodiments, be important to the production of a doped sol. For example, the addition of a dopant precursor to a neutral sol may, in some embodiments, result in only partial reaction between the dopant precursor and peptizing agent. In some such embodiments, the pH of the partially-doped sol may decrease (i.e., the sol may become more acidic), possibly rendering the partially-doped sol unstable. However, adding additional base (e.g., additional peptizing agent) to the sol during and/or after addition of the dopant precursor can be effective to both facilitate the reaction (leading to more complete conversion of the dopant precursor to dopant, i.e., metal oxide) and stabilize the resulting sol. It is noted that, accordingly, in certain embodiments, it may be advantageous to begin with a basic sol such that any pH adjustment during and/or after addition of the dopant precursor to maintain stability and/or promote the reaction, is minimized (or eliminated).

Although the foregoing disclosure focuses on the incorporation of a dopant precursor directly into the TiO₂ sol, it is noted that, in certain specific embodiments, the dopant precursor is first reacted (prior to combination with the TiO₂ sol) to provide the desired dopant. For example, a dopant precursor in the form of a metal salt or compound can first be reacted to produce a metal oxide (e.g., including but not limited to, a metal oxide in gel form); subsequently, that metal oxide can be directly combined with the TiO₂ sol to provide a doped TiO₂ sol as generally described herein. Any reagents can be employed that are suitable for the formation of a metal oxide dopant for addition to a sol in this manner. For example, a metal salt or compound can be reacted in some embodiments with sodium hydroxide in water to produce a metal oxide dopant for addition to a TiO₂ sol as disclosed herein. In such embodiments, the TiO₂ sol to which the dopant precursor is added is advantageously, although not limited to, a neutral sol.

In some embodiments, the doped TiO₂ sol (e.g., the metal oxide-doped TiO₂ sol) can be directly used. However, in certain embodiments, the doped sol can be further processed. It is generally understood that the final pH of the doped sol will differ somewhat from the pH of the neutral TiO₂ sol used to prepare the doped sol (due to the addition of the dopant precursor(s) and/or any other added components). In certain embodiments, the final pH of the doped sol product is a substantially neutral pH (e.g., about 6 to about 9). Where the pH deviates significantly from neutral (e.g., greater than about 9 or less than about 6), the pH of the TiO₂ sol may advantageously be adjusted in further preparations to account for the large pH shift in such embodiments (so that, rather than combining the dopant precursor(s) with a neutral TiO₂ sol, the dopant precursor(s) are combined with an acidic or basic TiO₂ sol to offset the pH shift). Alternatively, in some embodiments, the pH of the doped TiO₂ sol product may be directly adjusted through the addition of acid or base, as disclosed above.

In some embodiments, the sol is advantageously diluted (by adding liquid thereto) or concentrated (by removing liquid therefrom). Exemplary sols will typically comprise from about 0.5 to about 20% by weight titanium dioxide, based on the total weight of the composition. Exemplary sols will further typically comprise up to about 10% by weight dopant(s), such as about 0.1% to about 10% or about 0.5% to about 7.5% by weight of a dopant, based on the entirety of the doped sol. Additional solvent (e.g., the solvent of the sol, e.g., water) can be added to provide a doped sol having the desired TiO₂, and/or dopant content.

Further, depending on the ultimate use of the doped TiO₂ sols disclosed herein, the form of the sol can be modified, e.g., by including components designed to modify the physical properties of the sol (e.g., thickeners, binders, fillers, film-forming aids, and the like, such as those components disclosed in U.S. Pat. No. 7,776,954 to Stratton et al., which is incorporated herein by reference in its entirety). Again, any additional components combined with the doped TiO₂ sols advantageously do not significantly impact the adsorption characteristics and/or the photocatalytic characteristics of the doped sols.

The sol can be employed in various forms. For example, in some embodiments, the sol is deposited on a surface, e.g., to form a film. Relevant methods of deposition include, but are not limited to, dip coating, spray coating, and spin coating. In some embodiment, the amount of material deposited can depend, e.g., on the desired amount of TiO₂ and/or metal oxide to be coated on the surface. One of skill in the art is aware of means by which, using such deposition methods, the physical properties (e.g., surface coverage and film thickness) of the resulting film can be modified. The sols disclosed herein can be deposited on various surfaces, the compositions of which are not particularly limited. Representative surfaces onto which the metal doped sols are advantageously deposited can include, but are not limited to, metal surfaces, concrete surfaces, and fibrous surfaces. In some embodiments, the sol can be provided in a cast form (e.g., to provide the material in a desired shape, such as to form a stand-alone structure).

The resulting sol can be used in varying capacities. As noted herein, the doped TiO₂ sols generally exhibit properties that render them useful for the capture and/or treatment of H₂S gas. Although not intending to be limited thereto, it is believed that the dopant(s) adsorb the H₂S gas and the photoactive TiO₂ oxidizes the H₂S gas. Accordingly, in some embodiments, the sols disclosed herein can be used in the form of films, e.g., to treat (e.g., coat) equipment or other components that are likely to come into contact with gas streams containing H₂S.

Accordingly, the disclosure provides methods for treating gas streams comprising H₂S, comprising contacting a gas stream with a doped TiO₂ sol (e.g., a metal oxide doped TiO₂ sol) as generally disclosed herein. Advantageously, the treated gas stream comprises a lower H₂S concentration following contact with the doped sol. In certain embodiments, the adsorbed H₂S can be released from the doped sol in an oxidized form.

### EXPERIMENTAL

### Example 1—Preparation of 5% by Weight ZnO on TiO₂ Using Zinc Acetate

TiO₂ having a pH of ˜12.0 (100 g) is added to a baffled container and stirred with good agitation. A solution of 85% w/w phosphoric acid in water (1.2 g) is added to the container at a rate of 0.075 g/min. A zinc acetate solution is separately prepared by combining zinc acetate (2.2 g) with demineralized water (20.0 g). The zinc acetate solution is added to the TiO₂ mixture at a rate of ˜0.75 g/min. The resulting material has a final pH of 7.5. The material comprises 13.5% TiO₂ by weight and 5% ZnO by weight. The initial TiO₂ value is determined analytically and the dopant levels and final TiO₂ levels are calculated based, e.g., on the initial TiO₂ value and the amount of dopant added. The material is diluted with additional demineralized water to provide a material having a TiO₂ content of 10% by weight.

### Example 2—Preparation of 1% by Weight Niobium Oxide on TiO₂ Using Niobium Chloride

TiO₂ having a pH of about 12.0 (100 g) is added to a baffled container and stirred with good agitation. A solution of 85% w/w phosphoric acid in water (1.4 g) is added to the container at a rate of 0.075 g/min, giving a mixture having a pH of ˜9. A niobium chloride (NbCl₅) solution is separately prepared by combining NbCl₅ (0.43 g) with IMS (10.0 g). The NbCl₅ solution is added to the TiO₂ mixture at a rate of ˜0.75 g/min. The resulting material has a final pH of 8.0. The material comprises 14.9% TiO₂ by weight and 1% Nb by weight. The initial TiO₂ value is determined analytically and the dopant levels and final TiO₂ levels are calculated based, e.g., on the initial TiO₂ value and the amount of dopant added. The material is diluted with demineralized water to provide a material having a TiO₂ content of 10% by weight.

### Example 3—Preparation of 5% by Weight ZnO on TiO₂ Using Zinc Chloride

TiO₂ having a pH of ˜12.0 (100 g) is added to a baffled container and stirred with good agitation. A solution of 85% w/w phosphoric acid in water (1.2 g) is added to the container at a rate of 0.075 g/min, giving a mixture having a pH of ˜9.6. A zinc chloride solution is separately prepared by combining zinc chloride (1.39 g) with IMS (10.0 g). The zinc chloride solution is added to the TiO₂ mixture at a rate of ˜0.75 g/min. The resulting material has a final pH of 7.5. The material comprises 14.8% TiO₂ by weight and 5% ZnO by weight. The initial TiO₂ value is determined analytically and the dopant levels and final TiO₂ levels are calculated based, e.g., on the initial TiO₂ value and the amount of dopant added. The material is diluted with additional demineralized water to provide a material having a TiO₂ content of 10% by weight.

### Example 4—Preparation of 1% by Weight Copper Oxide on TiO₂ Using Copper Acetate

TiO₂ having a pH of ˜12.0 (100 g) is added to a baffled container and stirred with good agitation. A solution of 85% w/w phosphoric acid in water (1.2 g) is added to the container at a rate of 0.075 g/min, giving a mixture having a pH of ˜9.6. A copper acetate solution is separately prepared by combining copper acetate (0.43 g) with demineralized water (25.0 g). The copper acetate solution is added to the TiO₂ mixture at a rate of ˜0.75 g/min. The resulting material has a final pH of 9.8. The material comprises 13.18% TiO₂ by weight and 1% copper oxide by weight. The initial TiO₂ value is determined analytically and the dopant levels and final TiO₂ levels are calculated based, e.g., on the initial TiO₂ value and the amount of dopant added. The material is diluted with additional demineralized water to provide a material having a TiO₂ content of 10% by weight.

### Example 5—Preparation of 5% by Weight Copper Oxide on TiO₂ Using Copper Acetate

TiO₂ having a pH of ˜12.0 (100 g) is added to a baffled container and stirred with good agitation. A solution of 85% w/w phosphoric acid in water (1.2 g) is added to the container at a rate of 0.075 g/min, giving a mixture having a pH of ˜9.6. A copper acetate solution is separately prepared by combining copper acetate (2.1 g) with demineralized water (42.0 g). The copper acetate solution is added to the TiO₂ mixture at a rate of ˜1.5 g/min. The resulting material has a final pH of 7.3. The material comprises 11.49% TiO₂ by weight and 5% copper oxide by weight. The initial TiO₂ value is determined analytically and the dopant levels and final TiO₂ levels are calculated based, e.g., on the initial TiO₂ value and the amount of dopant added. The material is diluted with additional demineralized water to provide a material having a TiO₂ content of 10% by weight.

### Example 6—Preparation of 10% by Weight Zinc Oxide on TiO₂ Using Zinc Chloride

Zinc chloride (23 g) is combined with 100 g water. The zinc chloride solution is added to a container and stirred with good agitation. A solution of 1.3 g sodium hydroxide (1.3 g) in water (100 g) is separately prepared and added to the container over about a 30 minute time period, giving a white zinc oxide gel having a pH of ˜10.0. A TiO₂ sol is added to a baffled container and stirred with good agitation. The zinc oxide gel is added over a 30 minute time period. The resulting material has a final pH of 8.5. The material comprises 12.2% TiO₂ by weight, 10% zinc oxide, and 8% chloride by weight. The initial TiO₂ value is determined analytically and the dopant levels and final TiO₂ levels are calculated based, e.g., on the initial TiO₂ value and the amount of dopant added. The material is diluted with additional demineralized water to provide a material having a TiO₂ content of 10% by weight.

### Example 7—Comparison of Homogeneity of Doped Sols

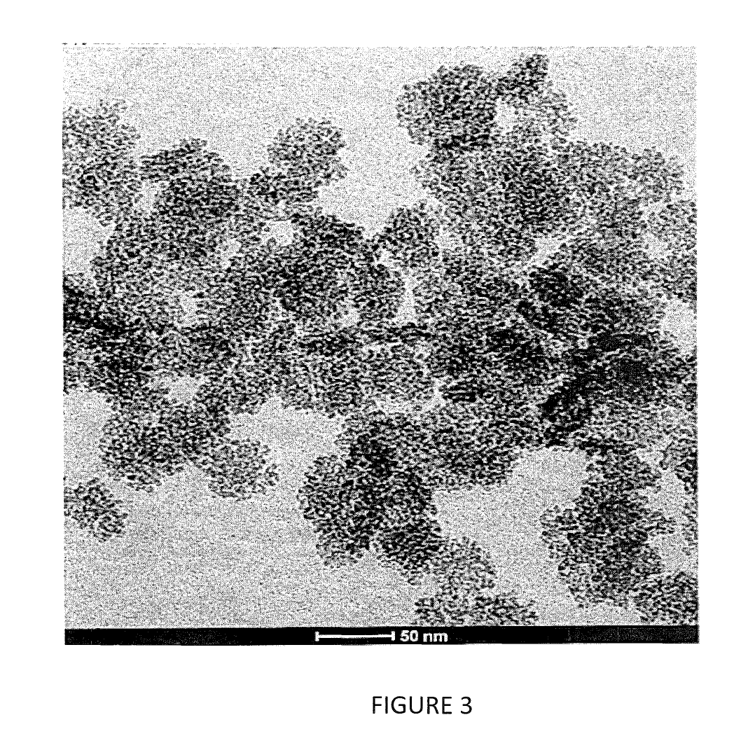

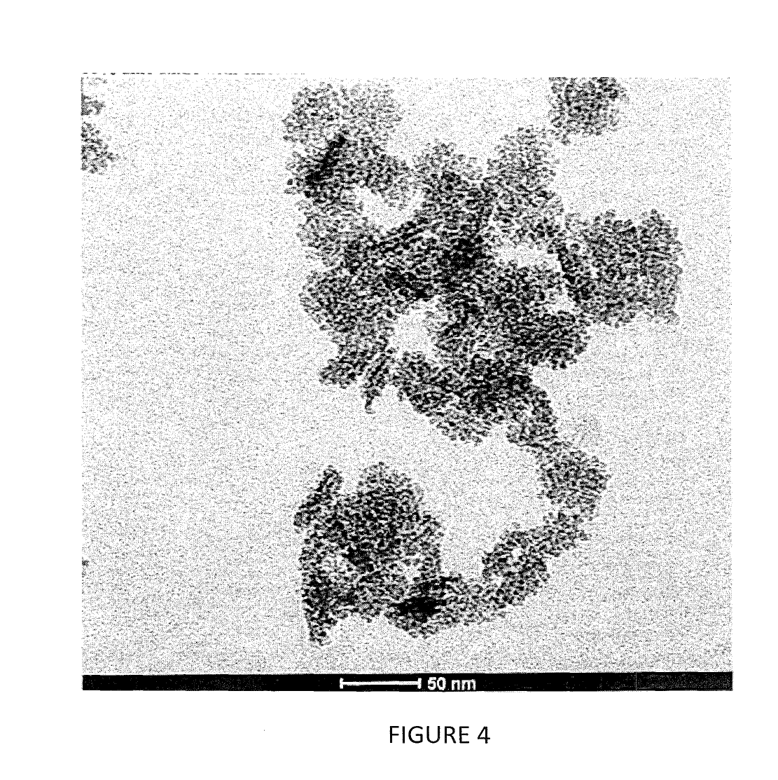

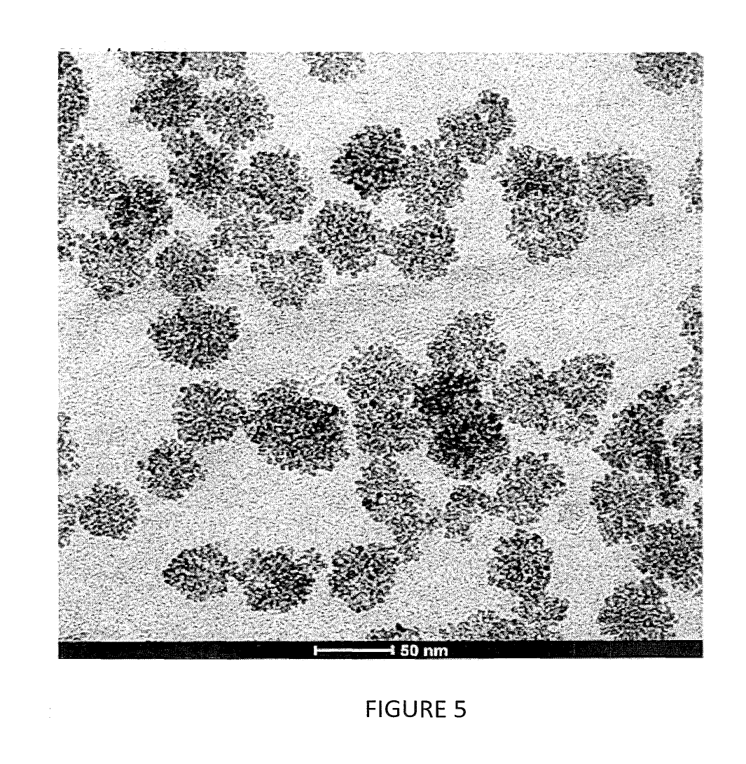

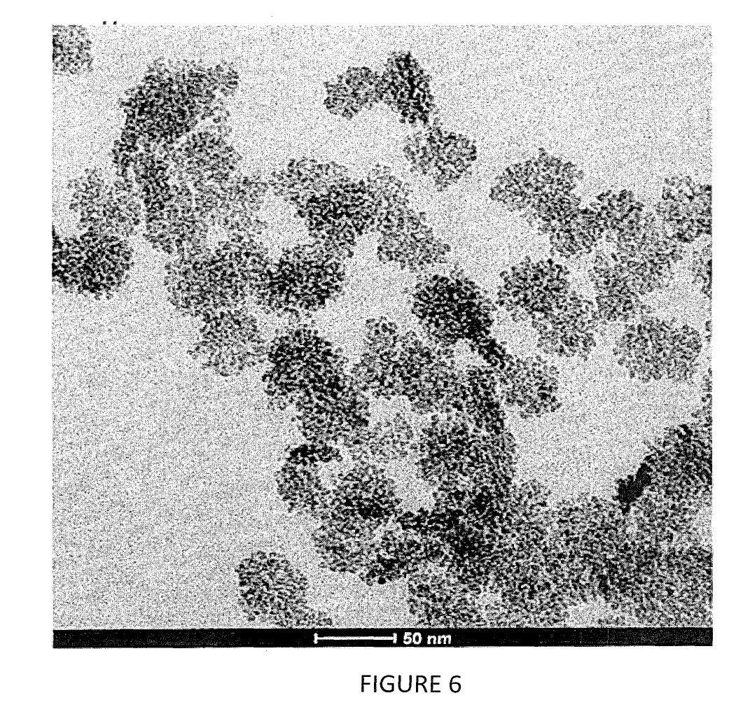

The doped TiO₂ sols prepared in these examples (i.e., Examples 1-6) were analyzed by transmission electron microscopy (TEM). All TEM images indicated that the dopants were uniformly distributed throughout the materials, as no clear separation between dopant and TiO₂ was observed. The TEM images were compared against TEM images of undoped TiO₂ sols, and the materials were largely indistinguishable, i.e., the dopant did not significantly affect the images. See FIG. 1 (undoped TiO₂ sol), as compared with FIG. 2 (TEM of doped sol of Example 1); FIG. 3 (TEM of doped sol of Example 3); FIG. 4 (TEM of doped sol of Example 6); FIG. 5 (Example 4); and FIG. 6 (Example 5).

### Example 8—Study of NOx Reduction (Photoactivity of Dried Films in UV Light)

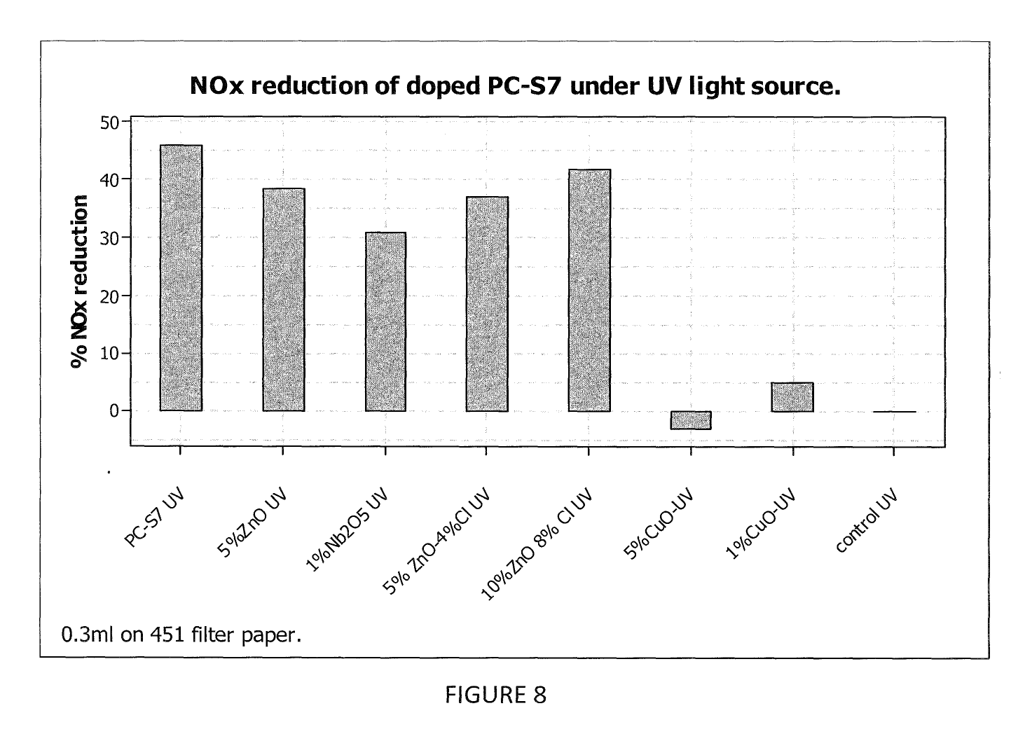

To study the photoactivity of the doped sols, various doped TiO₂ sols were coated onto filter paper (0.3 mL on 451 filter paper). The coated paper was subjected to a UV light source and the % NOx reduction was determined. As shown in FIG. 8, the results demonstrated no significant variation in NOx reduction due to the presence of zinc oxide and niobium oxide dopants (as compared with a comparable, undoped TiO₂ sol). In FIG. 8, the “control” material is represented as PC-S7, which is a stable aqueous (undoped) sol of ultrafine TiO₂ particles (about 10 wt. %) having a pH of about 8.5. As shown by the data in FIG. 8, ZnO-doped TiO₂ sols (in varying concentrations, with and without chloride) and Nb₂O₅-doped TiO₂ sols exhibited % NQ reductions that were within about 15% of the % reduction of the undoped sol (with the undoped sol exhibiting about a 45% reduction and the Nb₂O₅-doped TiO₂ sol exhibiting about a 31% reduction (with the ZnO-doped samples exhibiting reductions between those values). The CuO-doped sols exhibited little to no photoactivity. Although not intending to be limited by theory, it is believed that the copper dopant may be functioning within the doped sol as a recombination center, which can reduce photoactivity. However, it is recognized that this particular study uses NOx to test photoactivity and it cannot be assumed that the same would be true for other gases, e.g., H₂S.

### Example 9—Study of NOx Reduction (Photoactivity of Dried Films in Fluorescent Light)

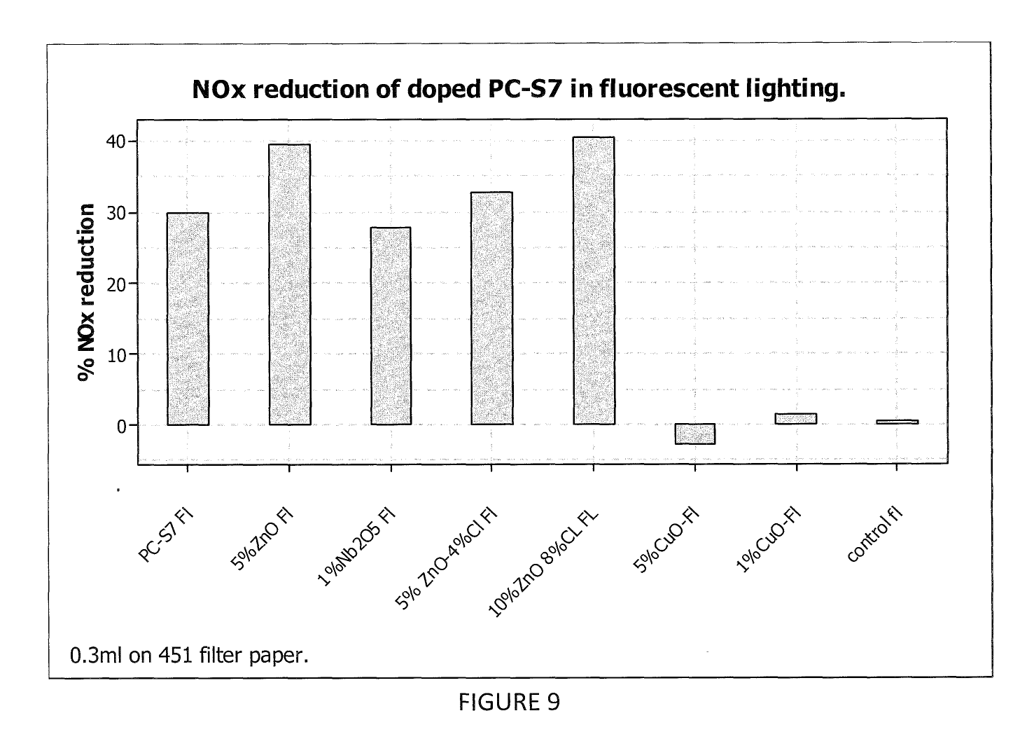

To study the photoactivity of the doped sols, various doped TiO₂ sols were coated onto filter paper (0.3 mL on 451 filter paper). The coated paper was subjected to a fluorescent light source and the % NOx reduction was determined. The results demonstrated no significant variation in NOx reduction due to the presence of zinc oxide and niobium oxide dopants (as compared with a comparable, undoped TiO₂ sol). As shown in FIG. 9, ZnO-doped TiO₂ sols (in varying concentrations, with and without chloride) and Nb₂O5-doped TiO₂ sols exhibited % NOx reductions that were within about 10% of the % reduction of the undoped sol (with the undoped sol exhibiting about a 30% reduction, the Nb₂O₅-doped TiO₂ sol exhibiting about a 28% reduction, and the ZnO-doped samples all exhibiting reductions greater than that of the undoped sol). It is believed that the ZnO-doped samples exhibitor greater reductions due to scattering of light from the zinc oxide. Again, the CuO-doped sols exhibited little to no photoactivity. Although not intending to be limited by theory, it is again believed that the copper dopant may be functioning within the doped sol as a recombination center, which can reduce photoactivity. However, it is recognized that this particular study uses NOx to test photoactivity and it cannot be assumed that the same would be true for other gases, e.g., H₂S.

### Example 10—Study of NOx Reduction (Photoactivity of Material Coated on Concrete in UV Light)

Zinc oxide, niobium oxide, and zinc oxide with chloride doped TiO₂ sols were coated onto concrete at an application rate of 12 g/m². These coated materials were naturally weathered over a period of 29 weeks and the NOx reduction was analyzed at various time points (1 week, 6 weeks, 20 weeks, and 29 weeks).

For the analysis of NOx reduction, the samples were placed in a NOx analyzer under a flow of NO at approximately 0.7 L/min. Readings were taken under applied fluorescent light (spectrum of 400 to 750 nm) at 7.24 W/m² and under ultraviolet light (spectrum of 290 to 400 nm) at 6.63 W/m². An EnviroTech NOx Analyzer model T200 was used. Further NOx analyzers are commercially available, such as from Teledyne Technologies Incorporated, Altech Environment USA, and Emerson Process Management. The NOx analyzer consists of a sealed test chamber (e.g., a quartz tube), a light source configured for illuminating the test chamber, a source of NO gas, tubing for delivery of the NO gas to the test chamber, an analyzer configured for detecting the presence of NOx, tubing for delivery of gas from the test chamber to the analyzer, a purified air (NOx-free) source, tubing for delivery of purified air to the test chamber, an optional humidifier for delivery of water vapor to the test chamber, valves, and pumps. At least the test chamber is in a light-proof container to enable “dark” readings. For each test, NOx concentration readings were taken without the applied light and then again with the applied light to evaluate the reduction of NOx under the photocatalytic conditions.

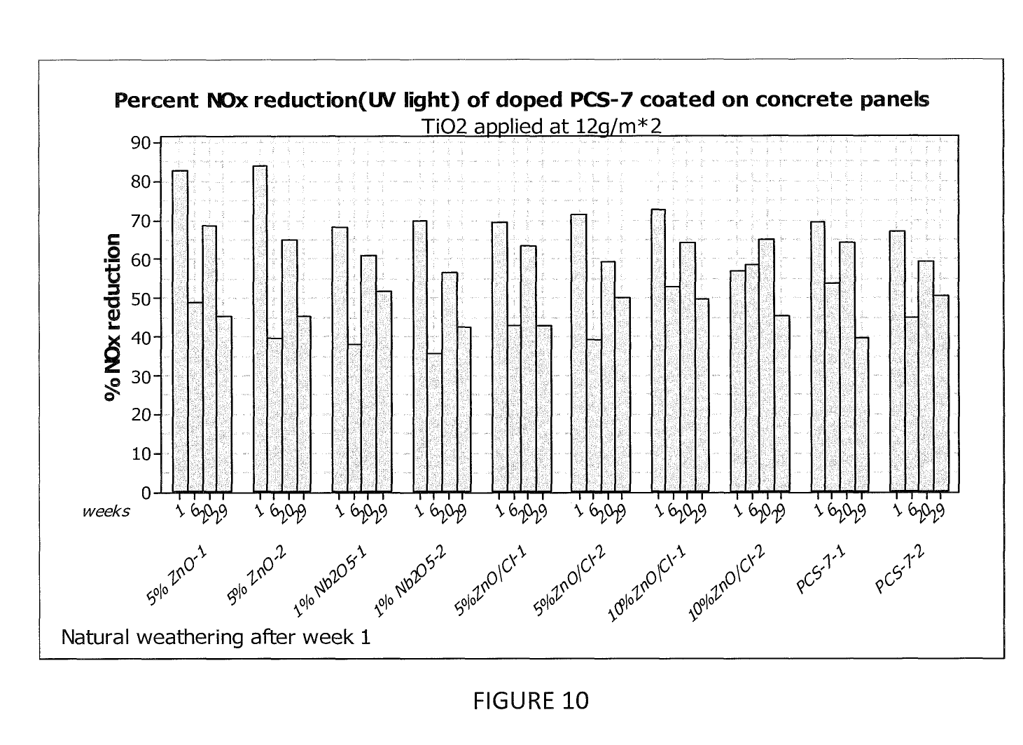

As shown in FIG. 10, the results indicate that no significant variation in NOx reduction was observed for the doped TiO₂ sols over this time range, as compared with a comparable, undoped TiO₂ sol.

### Example 9—Study of SO₄²⁻ Accumulation (Photoactivity of Material Coated on Painted Surfaces)

Styrene acrylic paint comprising photocatalytic TiO₂ powder (PC500) was applied to Melinex panels (comprising a flexible polyester film) to give a dry film thickness of about 15 microns. Each panel measured 4×15 cm, giving a surface area of 60 cm². Various doped sols were spray applied to these coated panels in the quantities provided below in Table 1 (giving 10 panels comprising each dopant system). One comparative set of 10 panels was provided with no doped sol applied thereto (comprising only the photocatalytic paint) and a second comparative set of panels was provided comprising only the styrene acrylic paint (with no photocatalytic TiO₂ powder contained therein).

TABLE 1
Doped sols applied to panels

| Dopant | % dopant | Total g/m² TiO₂ |
|---|---|---|
| Zinc oxide | 5 | 3.2 |
| Niobium oxide | 1 | 3.4 |
| Zinc oxide with chloride | 5 | 2.8 |
| Zinc oxide with chloride | 10 | 5.4 |
| Copper oxide | 1 | 3.9 |
| Copper oxide | 5 | 2.7 |

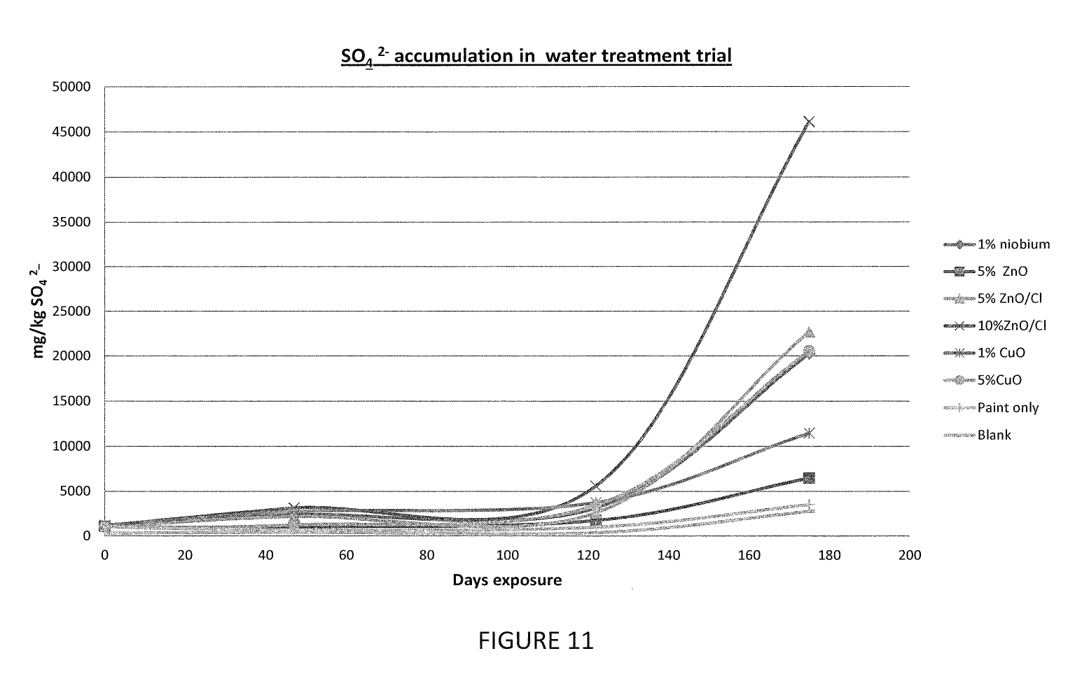

All panels were placed at a water treatment plant (wherein they were exposed to hydrogen sulfide, among other things) for a period of 180 days. Panels were removed from the site periodically and analyzed. The accumulation of SO₄²⁻ was measured by ion chromatography. The level of sulfate in the sample indicates that hydrogen sulfide has been absorbed by the metal oxide contained within the doped material and then oxidized photocatalytically by the TiO₂ in the material to give the sulfate form. The results of this study are provided in FIG. 11. In FIG. 11, the “paint only” sample is a panel coated with the styrene acrylic paint (but no photocatalytic TiO₂ powder) and the “blank” sample is a panel coated with the TiO₂ powder-containing paint. As shown in FIG. 11, the panels coated with the doped sols demonstrated greater SO₄²⁻ accumulation than either the panels coated with paint only or paint and photocatalytic TiO₂ powder.

The data presented in FIG. 11 demonstrates that the doped sol comprising zinc oxide with chloride, at a 10% dopant loading (followed by the doped sol comprising zinc oxide with chloride, at a 5% dopant loading), performed the best in this study (i.e., accumulated the greatest amount of hydrogen sulfide, represented by the amount of sulfate associated with the coated panel after roughly 175 days exposure). All tested panels coated with doped sols outperformed panels coated with only non-TiO₂-containing paint and also outperformed panels coated with only photocatalytic TiO₂-containing paint.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A composition comprising:
a solid phase comprising a first and second metal oxide, wherein the first metal oxide is titanium dioxide (TiO₂); and
a liquid phase.

2. The composition of claim 1, wherein the first and second metal oxide are uniformly dispersed throughout the composition.

3. The composition of claim 1, wherein at least a portion of the second metal oxide is adhered to at least a portion of the first metal oxide.

4. The composition of claim 3, wherein at least about 75 weight percent of the second metal oxide is adhered to at least a portion of the first metal oxide.

5. The composition of claim 1, wherein at least a portion of the second metal oxide is in the form of a coating on at least a portion of the first metal oxide.

6. The composition of claim 1, wherein the second metal oxide is selected from the group consisting of aluminum oxides, chromium oxides, zinc oxides, iron oxides, copper oxides, nickel oxides, cobalt oxides, molybdenum oxides, niobium oxides, manganese oxides, calcium oxides, barium oxides, strontium oxides, tungsten oxides, vanadium oxides, and mixed metal oxides thereof.

7. The composition of claim 1, wherein the second metal oxide is selected from the group consisting of zinc oxides, copper oxides, and mixed metal oxides thereof.

8. The composition of claim 1, further comprising chloride ions.

9. The composition of claim 1, wherein the composition comprises about 1% to about 15% by weight of the second metal oxide.

10. The composition of claim 1, wherein about 90% or more by weight of the first metal oxide is in the anatase phase.

11. The composition of claim 1, wherein the composition comprises about 5% to about 20% by weight of the first metal oxide.

12. The composition of claim 1, wherein the TiO₂ is in the form of crystallites having a primary particle size of about 10 nm to about 60 nm.

13. The composition of claim 1, wherein the weight ratio of first metal oxide to second metal oxide in the composition is greater than about 1:1.

14. The composition of claim 1, wherein the weight ratio of first metal oxide to second metal oxide in the composition is about 1.1:1 to about 20:1.

15. The composition of claim 1, wherein the composition is transparent.

16. The composition of claim 1, wherein the composition has a pH of about 6 to about 9.

17. The composition of claim 1, wherein the liquid phase comprises water.

18. The composition of claim 17, wherein the liquid phase further comprises one or more water-soluble peptizing agents.

19. The composition of claim 1, wherein the composition is a sol.

20. The composition of claim 1 wherein:
the second metal oxide is selected from the group consisting of zinc oxides, copper oxides, and mixed metal oxides thereof;
the composition comprises about 5% to about 15% by weight of the second metal oxide;
the composition comprises about 5% to about 20% by weight of the first metal oxide; and
the weight ratio of first metal oxide to second metal oxide in the composition is greater than about 1:1.

21. A method of preparing a metal oxide-doped TiO₂ composition comprising:
providing a composition, wherein the composition comprises a solid phase comprising titanium dioxide (TiO₂) and a liquid phase; and
combining the composition with one or more metal compounds or metal salts under conditions sufficient to result in reaction of the metal of the one or more metal compounds or metal salts to form a metal oxide, wherein the metal oxide is a metal oxide other than TiO₂, to give a metal oxide-doped TiO₂ composition.

22. The method of claim 21, wherein the TiO₂ is in the form of crystallites having a primary particle size of about 10 nm to about 60 nm.

23. The method of claim 21, wherein the liquid phase comprises water.

24. The method of claim 23, wherein the liquid phase further comprises one or more water-soluble peptizing agents.

25. The method of claim 21, wherein the at least a portion of the metal oxide forms such that it adheres to at least a portion of the TiO₂.

26. The method of claim 21, wherein the one or more metal compounds or metal salts are selected from the group consisting of aluminum salts, chromium salts, zinc salts, iron salts, copper, nickel salts, cobalt salts, molybdenum salts, niobium salts, manganese salts, calcium salts, barium salts, strontium salts, tungsten salts, vanadium salts, and combinations thereof.

27. The method of claim 21, wherein the one or more metal compounds or metal salts are selected from the group consisting of zinc salts, copper salts, and combinations thereof.

28. The method of claim 21, wherein the one or more metal compounds or metal salts are selected from the group consisting of halides, acetates, perchlorates, hydroxides, sulfates, sulfonates, nitrates, nitrites, oxides, trifluoroacetates, carbonates, bicarbonates, phosphates, tetrafluoroborates, citrates, periodates, pyruvates, triflates, acrylates, methacrylates, acetonates, azides, cyanides, methoxides, ethoxides, t-butoxides, isopropoxides, benzoates, and derivatives and combinations thereof.

29. The method of claim 21 wherein the one or more metal compounds or metal salts are selected from the group consisting of metal halides and metal acetates.

30. The method of claim 21, wherein the metal compounds or metal salts are in solution form.

31. The method of claim 21, wherein the one or more metal compounds or metal salts are in the form of a gel comprising a metal oxide.

32. The method of claim 21, wherein the composition is basic prior to said combining step.

33. The method of claim 21, further comprising adjusting the pH after the combining step to give a metal oxide-doped TiO₂ composition having a pH of about 6 to about 9.

34. A method of reducing atmospheric pollution by treating a gas comprising H₂S, comprising contacting the gas comprising H₂S with a metal oxide-doped TiO₂ composition such that at least a portion of the H₂S is adsorbed and such that at least a portion of the adsorbed H₂S is oxidized, wherein the metal oxide-doped TiO₂ composition comprises: a solid phase comprising a first and second metal oxide, wherein the first metal oxide is titanium dioxide (TiO₂); and a liquid phase.

35. The method of claim 34, wherein the metal oxide-doped TiO₂ composition is in the form of a dried film.

36. The method of claim 34, wherein the metal oxide-doped TiO₂ composition comprises zinc oxide and further comprises chloride ions.
